(19) United States
(12) Patent Application Publication
(10) Pub. No.: US 2010/0200687 A1
(43) Pub. Date: Aug. 12, 2010

(54) Seat belt retractor

(75) Inventors: Mark F. Gray, Sterling Heights, MI (US); Robert Rogers, Orion, MI (US)

Correspondence Address: FOLEY AND LARDNER LLP;SUITE 500, 3000 K STREET NW, WASHINGTON, DC, 20007, US

(73) Assignee: TK HOLDINGS INC.

(21) Appl. No.: 12/379,124

(22) Filed: Feb. 12, 2009

(51) Int. Cl. B60R 22/46; B65H 75/48; B60R 22/34

(52) U.S. Cl. 242/374

(57) ABSTRACT

A seat belt retractor includes a spool, a pinion connected to the spool, and a rack. The rack includes a first portion having a first set of teeth and a second portion having a second set of teeth of a smaller width than the teeth of the first portion. The first set of teeth and the second set of teeth are configured to engage with the pinion of the seat belt retractor.

### BACKGROUND

The present application generally to the field of seat belt retractors. More specifically, the present disclosure relates to a seat belt retractor pretensioner.

Current retractor pretensioners may include two types, those that drive a spool of the retractor directly and those that drive the spool through a torsion bar. If the spool is driven directly, an undesired effect may occur during the initial payout of the belt. Unless a clutch to separate the spool from the driver for the spool is provided, during the initial payout, the occupant may be subject to additional loads due to the resistive force of the pretensioner. Even if a clutch is provided, the initial energy absorbing motion of the webbing and the retractor may still be affected because a clutch requires some reverse motion in operation. Retractors that include spools driven through a torsion bar may reduce detrimental effects on the ability of the seat belt system to absorb energy, but these systems also limit the ability of a pretensioner to pretension due to the torsion bar.

Therefore, there is a need for a seat belt system including a retractor and pretensioner that does not increase loads on the occupant. Additionally, there is a need for a seat belt retractor pretensioner, that does not influence the initial energy absorbing motion of the webbing.

### SUMMARY

One disclosed embodiment relates to a seat belt retractor including a spool, a pinion connected to the spool, and a rack. The rack includes a first portion with a first set of teeth and a second portion with a second set of teeth of a smaller width than the teeth of the first portion. The first set of teeth and the second set of teeth are configured to engage with the pinion.

Another disclosed embodiment relates to a seat belt device including a seat belt and a seat belt retractor. The seat belt retractor includes a spool, a pinion connected to the spool, and a rack. The rack includes a first portion with a first set of teeth and a second portion with a second set of teeth of a smaller width than the teeth of the first portion. The first set of teeth and the second set of teeth are configured to engage with the pinion.

### BRIEF DESCRIPTION OF THE DRAWINGS

FIG. 1 is an isometric view of a seat belt retractor, according to an exemplary embodiment.

FIG. 2A is an end view of a locking mechanism of a seat belt retractor in an unlocked state, according to an exemplary embodiment.

FIG. 2B is an end view the locking mechanism of FIG. 2A in a locked state.

FIG. 3A is a side view of a seat belt pretensioner, according to an exemplary embodiment.

FIG. 3B is an isometric view of a rack, according to an exemplary embodiment.

FIG. 3C is an isometric views of a pinion, according to an exemplary embodiment.

FIG. 3D is an isometric views of a pinion, according to an exemplary embodiment.

### DETAILED DESCRIPTION

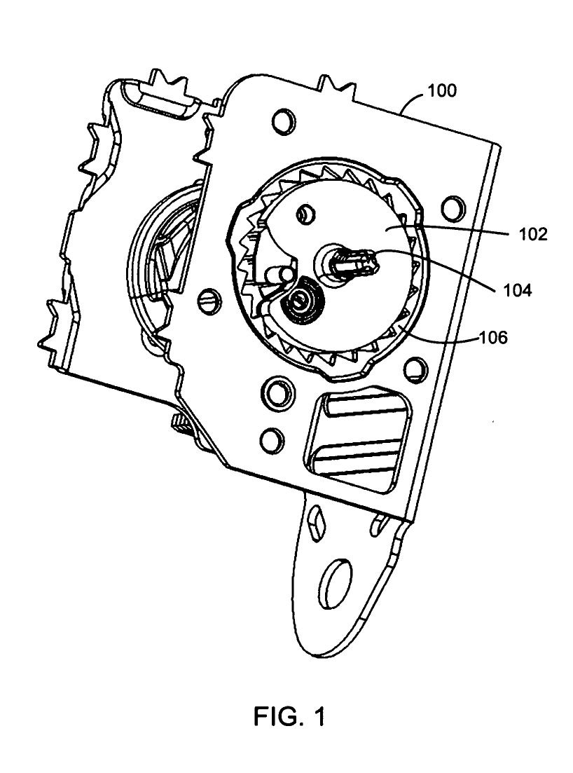

Referring to FIG. 1, an isometric view of a seat belt retractor 100 is shown, according to an exemplary embodiment. The seat belt retractor 100 includes a locking mechanism 102. The seat belt retractor 100 additionally includes a series of ratchet teeth 106 arranged in an annular manner to surround the locking mechanism 102. Furthermore, the seat belt retractor 100 includes a torsion bar 104. The torsion bar 104 connects a spool (not shown in FIG. 1) and a pinion (not shown in FIG. 1) to the seat belt retractor 100.

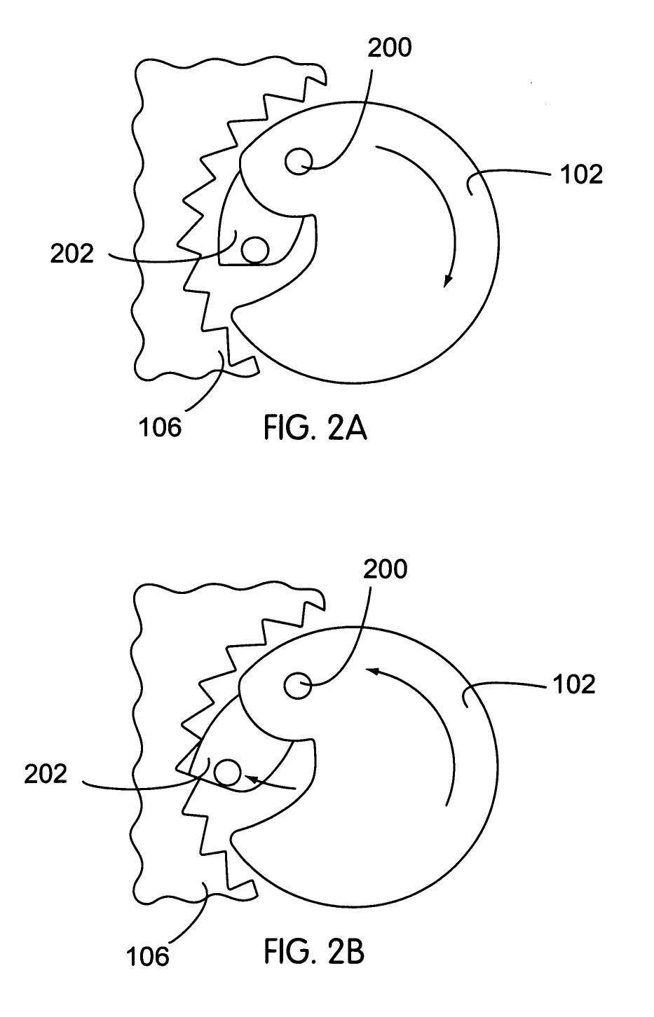

FIGS. 2A and 2B show examples of the locking mechanism 102 in an unlocked state and a locked state, respectively. The locking mechanism 102 is connected to a spool (not shown in FIGS. 2A and 2B) of the retractor such that the locking mechanism 102 may permit rotation of the spool when the locking mechanism 102 is in an unlocked state, such as in the example of FIG. 2A, or prevent rotation of the spool when the locking mechanism is in a locked state, such as in the example of FIG. 2B. The locking mechanism 102 may include a pivot point 200 and a locking pawl 202 that is rotatably connected to the locking mechanism 102 via the pivot point 200.

The locking pawl 202 may pivot about the pivot point 200 between an operative position in which the locking mechanism is locked and an inoperative position in which the locking mechanism is unlocked. For example, FIG. 2A shows the locking mechanism 102 with the locking pawl 202 in an inoperative position. When the locking pawl 202 is in the inoperative position the locking pawl 202 may be withdrawn in relation to an outer circumference of the locking mechanism 102 so that the locking pawl 202 does not engage the ratchet teeth 106. Thus, the locking mechanism 102 may freely rotate when the locking pawl 202 is in the unlocked, inoperative position. As a result, a spool connected to the locking mechanism 102 may also freely rotate, thereby allowing the seat belt to be withdrawn or retracted.

FIG. 2B shows an example of the locking mechanism 102 with a locking pawl 202 in an operative position. The locking pawl 202 may be positioned in the operative position to lock the locking mechanism 102 by pivoting about the pivot point 200, causing the locking pawl 202 to abut against the ratchet teeth 106. The locking mechanism 102 and the locking pawl 202 may be configured to engage the ratchet teeth 106 when the locking mechanism 102 rotates in the belt withdrawal direction, such as when a seat belt is withdrawn from the spool.

When the locking pawl 202 engages any of the ratchet teeth 106, the locking mechanism 102 may be prevented from rotating. Thus, the spool may not rotate when the locking pawl 202 engages the ratchet teeth 106, preventing the seat belt from being withdrawn. For example, the locking mechanism 102 may be configured such that the locking pawl 202 rotates to the locking position in an emergency situation to prevent further withdrawal of the seatbelt.

Furthermore, the locking pawl 202 may move freely along the ratchet teeth 106 when the locking mechanism 102 and associated spool rotate in the seatbelt retracting direction, even when the locking pawl 202 is in the operative, locking position. Therefore, when the locking mechanism 102 is in the operative position, the seat belt may be retracted but not withdrawn.

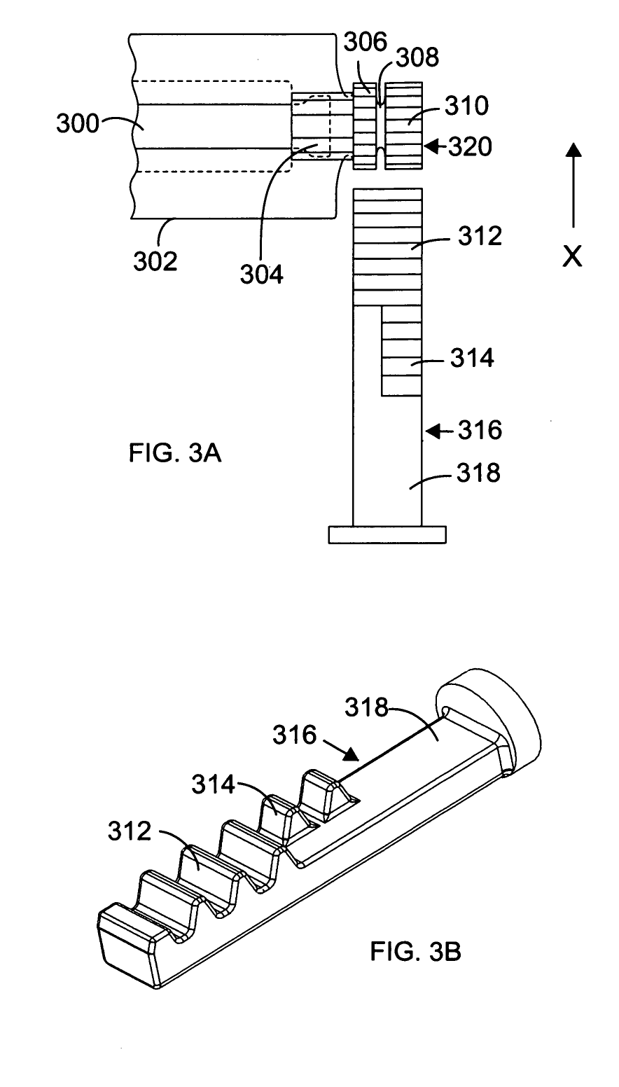

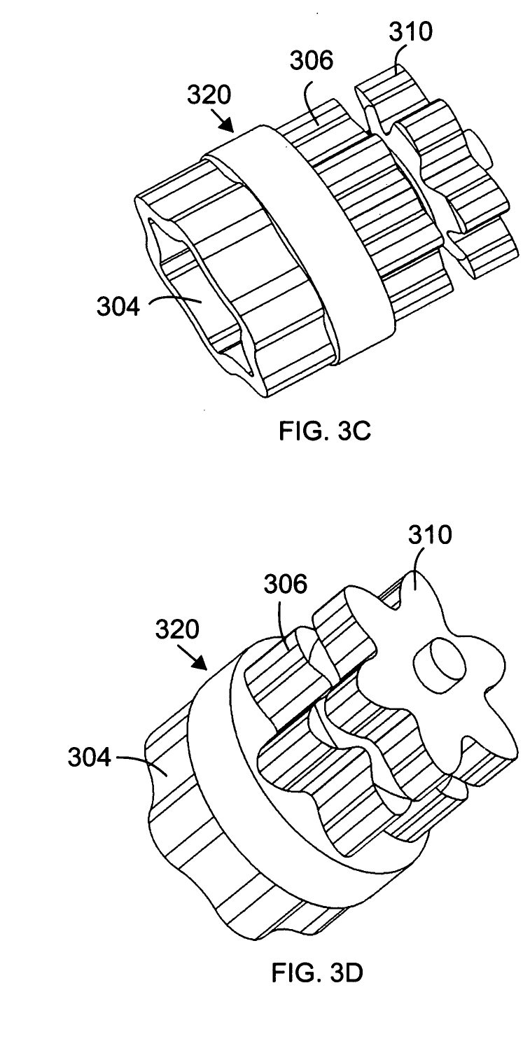

FIG. 3A shows an example of a seatbelt pretensioner. The pretensioner may include a torsion bar 300, a pinion 320, and a rack 316. The pretensioner may be, for example, located on a side of a retractor opposite to the locking mechanism shown in FIG. 1. The torsion bar 300 may be attached to the locking mechanism 102 (not shown in FIG. 3A) and a spool 302 for winding a seatbelt. The torsion bar 300 may be attached to the pinion 320. For example, the torsion bar 300 may be connected to the pinion 320 by a torsion bar adapter 304. The torsion bar 304 also connects the pinion 320 to the spool 302. The torsion bar adapter 304 may be integral to the pinion 320 such that the torsion bar adapter 304 and the pinion 320 have a monolithic, one-piece construction, or the torsion bar adapter 304 and pinion 320 may be formed by separate pieces connected together.

As shown in the example of FIG. 3B, the rack 316 may include a first portion 312 and a second portion 314. As shown in the examples of FIGS. 3A and 3B, the first portion 312 may include teeth and the second portion 314 may include teeth with a width that is smaller than the teeth of the first portion 312. The teeth of the first portion 312 and the second portion 314 may be configured to engage with the pinion 320, as will be explained below.

The first portion 312 of the rack 316 may include teeth that have the same or substantially same width as the rack 316. The second portion 314 of the rack 316 may include teeth that have, for example, a width that is half of the width of the rack 316.

Furthermore, the rack 316 may include a section 318 with no teeth, as shown in the examples of FIGS. 3A and 3B. Such a section 318 may be configured to not engage with a pinion 320, as will be explained below.

As shown in the example of FIGS. 3A, 3C, and 3D, the pinion 320 may include a first engagement portion 310 and a second engagement portion 306. The pinion also includes a connection portion 308 that is arranged between the first engagement portion 310 and the second engagement portion 306. The connection portion 308 may be configured to connect the first engagement portion 310 and the second engagement portion 306. For example, the connection portion 308 may be configured to connect the first engagement portion 310 to the second engagement portion 306 and the remainder of the pinion 320. Additionally, the pinion 320 may include the torsion bar adapter 304 as discussed herein.

The connection portion 308 may be configured to break when a predetermined amount of force is applied to the pinion 320. For example, the predetermined amount of force may be the force necessary to break the weakest part of the connection portion 308. The predetermined amount of force may be applied to the pinion 320 during winding of the spool 302 of the retractor, such as when the rack 316 applies a force to the pinion 320 of the retractor. The connection portion 308 may be configured to break along a shear plane when a force greater than a predetermined amount of force is applied to the pinion 320. The connection portion 308 may be configured such that when the connection portion 308 breaks the first engagement portion 310 is separated from the second engagement portion 306 and remainder of the pinion 320.

The first portion 312 of the rack 316 may be configured to engage with both the first engagement portion 310 and second engagement portion 306 of the pinion 320 when the rack 316 engages with the pinion 320. For example, the teeth of the first portion 312 of the rack 316 may engage with the first engagement portion 310 and the second engagement portion 306 of the pinion 320 due the relatively wide width of the teeth of the first portion 312. Thus, the first portion 312 of the rack 316 may be used to drive the pinion 320 via the first engagement portion 310 and the second engagement portion 306 of the pinion 320.

The second portion 314 of the rack 316 may be configured to engage with only the first engagement portion 310 of the pinion 320. For example, the teeth of the second portion 314 of the rack 316 may engage with the first engagement portion 310 of the pinion 320 due the relatively narrow width of the teeth of the second portion 314. The teeth of the second portion 314 may also positioned on the rack 316 to be aligned with the first engagement portion 310, as shown in the example of FIG. 3A. Thus, the second portion 314 of the rack 316 may be used to drive the pinion 320 via the first engagement portion 310 of the pinion 320 and not the second engagement portion 306 of the pinion 320.

The seatbelt pretensioner may be used to remove slack from a seatbelt, such as by winding the seatbelt on the spool 302 of the retractor and applying a tension to the seatbelt. This operation may be accomplished, for example, by engaging the rack 316 with the pinion 320 to drive the spool 302 via the torsion bar 300. A rack driving device may be provided to drive the rack 316 in a direction to engage with the pinion 320 and wind the seatbelt on the spool 302, such as in an upwards direction, such as the direction indicated by arrow X in FIG. 3A. The rack driving device may be, for example, powered by a propellant, a pyrotechnic, or another method used in the art.

For example, in the event of an emergency, the rack 316 may be activated via the rack driving device, thereby engaging of the rack 316 with the pinion 320. As a result of the rack 316 acting on the pinion 320, the spool may be rapidly rotated in the belt retracting direction. For example, during an initial phase of driving the rack 316, the teeth of the first portion 312 of the rack 316 may engage with both the first engagement portion 310 and the second engagement portion 306 of the pinion 320 to accelerate the spool 302. Due to the engagement of the teeth of the first portion 312 of the rack 316 with both the first engagement portion 310 and the second engagement portion 306, the teeth of the first portion 312 may be stronger than the teeth of the second portion 314 of the rack 316.

During a subsequent phase of driving the rack 316 to engage with the pinion 320, the second portion 314 of the rack 316 engages with the pinion 320. In this phase, for example, the teeth of the second portion 314 may engage with the first engagement portion 310 of the pinion 320 but not the second engagement portion 306. Thus, the subsequent phase of driving the rack 316 may continue the winding and tensioning operation of the seatbelt.

If the seatbelt has a relatively large amount of slack, such as a greater amount of slack than the pretensioner may retract, the rack 316 will be driven to engage the pinion 320 during the first and subsequent phase, causing the seatbelt to be wound and tensioned during the first and subsequent phase. In this operation, the teeth of the first portion 312 of the rack 316 may engage with the first engagement portion 310 and the second engagement portion 306 of the pinion 320 during the first phase, and the teeth of the second portion 314 of the rack 316 may engage with the first engagement portion 310 and not the second engagement portion 306 of the pinion 320 during the subsequent phase.

Furthermore, driving of the rack 316 may continue such that the second portion 314 of the rack 316 is driven past the pinion 320 so that the third portion 318 of the rack 316 is positioned above the pinion 320. For example, the driver for the rack 316 may be configured to provide sufficient force, such as via sufficient propellant or pyrotechnic, to driver the first portion 312, the second portion 314, and the third portion 318 of the rack 316 past, the pinion 320. However, because the third portion 318 of the rack 316 does not contain any structure to engage with the pinion 320, such as teeth, the third portion 318 does not engage with the pinion 320. Thus, the rack 316 may be disengaged from the pinion 320, and the spool 302 and pinion 320 may continue to spin due to any movement and inertia imparted to these components during the first and subsequent phases of driving the rack 316 until this inertia is exhausted. This arrangement advantageously permits the seatbelt to achieve a high level of pretensioning without the spool remaining connected to the driving components of the pretensioner.

If the seatbelt has a relatively low amount of slack, such as a lower amount of slack than the pretensioner may retract, the slack, or a major portion thereof, will be consumed before driving of the rack 316 through the first and subsequent phases is complete. Thus, after the slack of the seatbelt is consumed, the seatbelt will tighten and an increased amount of force will be applied to the components of the retractor.

To avoid the increased amount of force and any detrimental effects to the energy absorbing function of the retractor, the pretensioner may be configured to disconnect the driver of the pretensioner from the spool. For example, during the subsequent phase of driving a rack 316, the second portion 314 of the rack 316, such as the teeth of the second portion 314, engage the pinion, such as the first engagement portion 310 of the pinion 320 but not the second engagement portion 306 of the pinion 320. When the slack of the seatbelt is consumed, the amount of force applied between the second portion 314 of the rack 316 and the first engagement portion 310 with increase greatly. This force may become greater than the predetermined amount of force necessary to break the connection portion 308 between the first engagement portion 310 and the second engagement portion 306 of the pinion 320. For example, the force applied during the subsequent phase may cause the connection portion 308 to shear when the connection portion 308 is constructed as a shear plane.

When the driver is disconnected from the spool, the spool is permitted to spin freely. For example, when the connection portion 308 fails due to the application of force greater than the predetermined amount of force necessary to break the connection portion 308, the rack 316.may be disconnected from the portion of the pinion 320 still connected to the spool. This may be accomplished when the connection portion 308 fails during the subsequent driving phase when the teeth of the second portion 314 of the rack 316 is only engaged with the first engagement portion 310 of the pinion 310. Because the connection portion 308 that connects the first engagement portion 310 to the second engagement portion 306, and the remainder of the pinion 320, has failed, the spool may rotate freely in relation to the rack 316 and the first engagement portion. After the connection portion 308 has failed in this manner the first engagement portion 310 and the second engagement portion 306 of the pinion 320 may move relative to one other. For example, the first and second engagement portions may be separated from one another when the connection portion 308 fails. Thus the first engagement portion 310 may be driven by the rack 316 and may move relative the remainder of the pinion 320 and the spool when the connection portion 308 fails and the rack 316 is disconnected from the spool.

Thus, the arrangement above provides a load limiting driver for the retractor in that the driver limits the force that the pretensioner may apply to a seatbelt to a desired level, such as by disconnecting the driver from the spool of the retractor. In the example above, the disconnection is caused by a failure, such as shear, but the disconnection may be accomplished by other structures or methods.

Although the examples above used a rack and pinion type of driver for the retractor, the load limiting device of the retractor may be formed with other types of drivers known in the art. For example, the driver may be formed by a ball driver such that balls contact first and second engagement portions of the pinion during a first phase, and balls contact only one of these engagement portions during a subsequent phase.

While exemplary embodiments are illustrated in the figures and described above, it should be understood that these embodiments are offered by way of example only. For example, the teachings herein may be applied to any retractor pretensioner and are not limited to a rack and pinion driving style.

What is claimed is:

1. A seat belt retractor, comprising:
a spool,
a pinion connected to the spool, and
a rack including a first portion having a first set of teeth and a second portion having a second set of teeth of a smaller width than the teeth of the first portion, wherein the first set of teeth and the second set of teeth are configured to engage with the pinion.

2. The seat belt retractor of claim 1, wherein the first set of teeth have the same width as the rack.

3. The seat belt retractor of claim 2, wherein the width of the second set of teeth is half of the width of the rack.

4. The seat belt retractor of claim 1, wherein the rack further includes a third portion without teeth so that the third portion of the rack does not engage with the pinion.

5. The seat belt retractor of claim 1, wherein the pinion has a first engagement portion and a second engagement portion that are separated from one another, wherein the first portion of the rack is configured so that the first set of teeth engage both the first engagement portion and the second engagement portion of the pinion, wherein the second portion of the rack is configured so that the second set of teeth engage the first engagement portion of the pinion and not the second engagement portion of the pinion.

6. The seat belt retractor of claim 5, wherein the pinion is configured to break between the first engagement portion and the second engagement portion of the pinion.

7. The seat belt retractor of claim 6, wherein the pinion is configured to break when a force applied to the pinion exceeds a predetermined amount while the second set of teeth is engaging the first engagement portion of the pinion.

8. The seat belt retractor of claim 7, wherein the first engagement portion of the pinion is configured to move relative to the second engagement portion of the pinion after the pinion is broken.

9. The seat belt retractor of claim 1, further comprising a rack driving device.

10. The seat belt retractor of claim 9, wherein the rack driving device is powered by a propellant.

11. The seat belt retractor of claim 1, further comprising a spool locking mechanism.

12. The seat belt retractor of claim 1, further comprising a torsion bar, wherein the torsion bar connects the pinion to the spool.

13. A seat belt device, comprising:
a seat belt, and
a seat belt retractor, comprising:
a spool,
a pinion connected to the spool, and
a rack including a first portion having a first set of teeth and a second portion having a second set of teeth of a smaller width than the teeth of the first portion, wherein the first set of teeth and the second set of teeth are configured to engage with the pinion.

14. The seat belt device of claim 13, wherein the first set of teeth have the same width as the rack.

15. The seat belt device of claim 14, wherein the width of the second set of teeth is half of the width of the rack.

16. The seat belt device of claim 13, wherein the rack further includes a third portion without teeth so that the third portion of the rack does not engage with the pinion.

17. The seat belt device of claim 13, wherein the pinion has a first engagement portion and a second engagement portion that are separated from one another, wherein the first portion of the rack is configured so that the first set of teeth engage both the first engagement portion and the second engagement portion of the pinion, wherein the second portion of the rack is configured so that the second set of teeth engage the first engagement portion of the pinion and not the second engagement portion of the pinion.

18. The seat belt device of claim 17, wherein the pinion is configured to break between the first engagement portion and the second engagement portion of the pinion.

19. The seat belt device of claim 18, wherein the pinion is configured to break when a force applied to the pinion exceeds a predetermined amount while the second set of teeth is engaging the first engagement portion of the pinion.

20. The seat belt device of claim 19, wherein the first engagement portion of the pinion is configured to move relative to the second engagement portion of the pinion after the pinion is broken.
